(19) United States
(12) Patent Application Publication
(10) Pub. No.: US 2010/0285441 A1
(43) Pub. Date: Nov. 11, 2010

(54) Global Computer Network Self-Tutoring System

(76) Inventor: Neil T. Hefferman, Worcester, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/532,905

(22) PCT Filed: Mar. 28, 2008
(86) PCT No.: PCT/US2008/004061

§ 371 Date: Jul. 21, 2010

Related U.S. Application Data
(60) Provisional application No. 60/908,579, filed on Mar. 28, 2007.
(60) Provisional application No. 60/937,953, filed on Jun. 29, 2007.

(51) Int. Cl. G09B 7/00

(52) U.S. Cl. 434/350

(57) ABSTRACT

A global computer network method and apparatus for creating and deploying many types of self-tutoring systems across many different platforms is disclosed. A run time engine supports several types of tutorials, in both a client and server context. A Builder enables development and testing of tutorials, formed of teacher composed problems, or an existing approved problems set, or student-user composed problems. The system simplifies the process of tutorial construction to allow educators and students with little or no ITS experience to develop content of problems and teaching strategies (i.e., format of problems including hints, messages and sequencing of related problems). The system provides a Web based interface as a means to build and store these tutorials. A web based reporting component allows for live database reporting to teachers, showing how students are performing. A testing component is web based and allows a teacher to test the quality of student composed problems. Further, the testing component allows addition of the student content to the existing approved problem set as is pertinent. Automated analysis and reporting of experimental tutorials developed by either teacher or student is included.

### RELATED APPLICATIONS

This application claims the benefit of U.S. Provisional Application No. 60/908,579 filed Mar. 28, 2007, and U.S. Provisional Application No. 60/937,953, filed Jun. 29, 2007, both by assignee.

The subject matter of the present invention is also broadly related to the online tutorial systems of PCT/US2006/027211 filed Jul. 13, 2006 which claims the benefit of U.S. Provisional Application No. 60/699,625 filed Jul. 15, 2005. The present application is a continuation-in-part of this PCT patent application.

The entire teachings of the above applications are incorporated herein by reference.

### GOVERNMENT SUPPORT

The invention was supported, in whole or in part, by contracts ONR (Office of Navel Research) N00014-0301-0221, U.S. Department of Education R305K030140, and NSF (National Science Foundation) REC0448319. The Government has certain rights in the invention.

### BACKGROUND OF THE INVENTION

Tutoring systems are helpful in providing instruction to students. Computer automated and in particular intelligent tutoring systems (ITS) are however complex and costly to construct. A current example of an ITS is that of the web-based ASSISTment system. This tutoring system performs “intelligent tutoring” in a web based manner, that allows teachers to author content themselves, and provides web-based reporting.

Unfortunately web-based tutoring systems are lacking in several respects. First, students are generally not provided a means to comment on or provide feedback or input to authoring of the tutorial content. Second, the web-based tutoring system is not “open-source” similar to that of Wikipedia allowing authored content to be viewed by many school districts. Third, an “open-source” type system suffers from the inherent flaw that the system itself cannot determine the quality of a user's contributions.

### SUMMARY OF THE INVENTION

The present invention addresses the disadvantages of and areas lacking in the prior art.

In a preferred embodiment, a computer-based tutoring system of the present invention is generally formed of four parts, namely a run time engine, a tutorial composer referred to as “Builder,” a Web reporting system, and a testing component. The run time engine takes XML (or other suitable) files that represent the interface and the behavior of the intelligent tutoring system and renders them in a server-side manner in either Java Web start mode or into HTML pages, flash interfaces of the like.

The “Builder” is a Web service application that allows teachers (authors) to compose and add interesting content to problems/test questions (generally “tutorials”). Other systems might allow a teacher to post test questions and answers online but do not allow an educator to create scaffolding questions contingent upon whether a student gets one or more items wrong. The “Builder” also allows for a first student, with teacher approval and supervision, to compose and add interesting content to problems/test questions. This is another area where other systems are lacking. The first student is also given the ability to create scaffolding questions. The premise behind this being that the best way for a person to learn something is to have to teach it. In addition to authoring scaffolding questions, teachers and students can create bug messages and hint messages in the present invention. Thus the builder enables teachers to form teaching strategies, and also enables students to form self-teaching strategies. Further, various media may be employed in the composed problems (tutorials).

For each student-user, the run time engine interactively displays any combination of (i) the first student composed problems, (ii) the teacher composed problems, or (iii) problems from an existing approved problem set to the student-user according to a curriculum and the teaching strategies. The teaching strategies enable any combination of teacher or student authored explanations, hints, messages and scaffolding of the problems to be displayed in response to the student-user interaction/action (responses). The first student is preferably one of the student-users or is a peer of the student-users.

The Web based reporting system allows for live database reporting to teachers in their classrooms, showing how their students are doing. A logger unit for logging student activity with or use of the invention system and a data store for storing indications of logged student activity supports the reporting system.

The testing component enables a teacher to test the quality of the first student composed problems. The testing component allows the teacher to create test groups for testing the student created problems by using the problems in tutoring sessions of the run-time engine. The results of the tutoring sessions with approved problems sets are then compared to results of those sessions with the first student composed problems. The comparisons are sent to an administrator to determine whether student composed problems can be generalized to other schools. Further, the testing component allows the administrator to add the student authored content to the existing approved problem set as is pertinent.

### BRIEF DESCRIPTION OF THE DRAWINGS

The foregoing, and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a screen view showing the BUILDER web tool, on the left, to create content, which is shown in the top-right corner.

FIG. 2 is a flow diagram of several screen views demonstrating student login, as well as demonstrating the system web portal allowing the teacher to access different tools.

FIG. 3 is an example output from the reporting system—a grade book, showing, for each student, how much time they spent, some data of their performance, as well as how many hints they asked for.

FIG. 4 is a high level flow chart demonstrating the present invention functionality including a student self-teaching model.

FIG. 5 is a flow chart of the student self-teaching model in one embodiment.

FIGS. 6 and 7 are schematic and block diagrams of a computer network and computer architecture in which embodiments of the present invention operate.

### DETAILED DESCRIPTION OF THE INVENTION

### The ASSISTment System

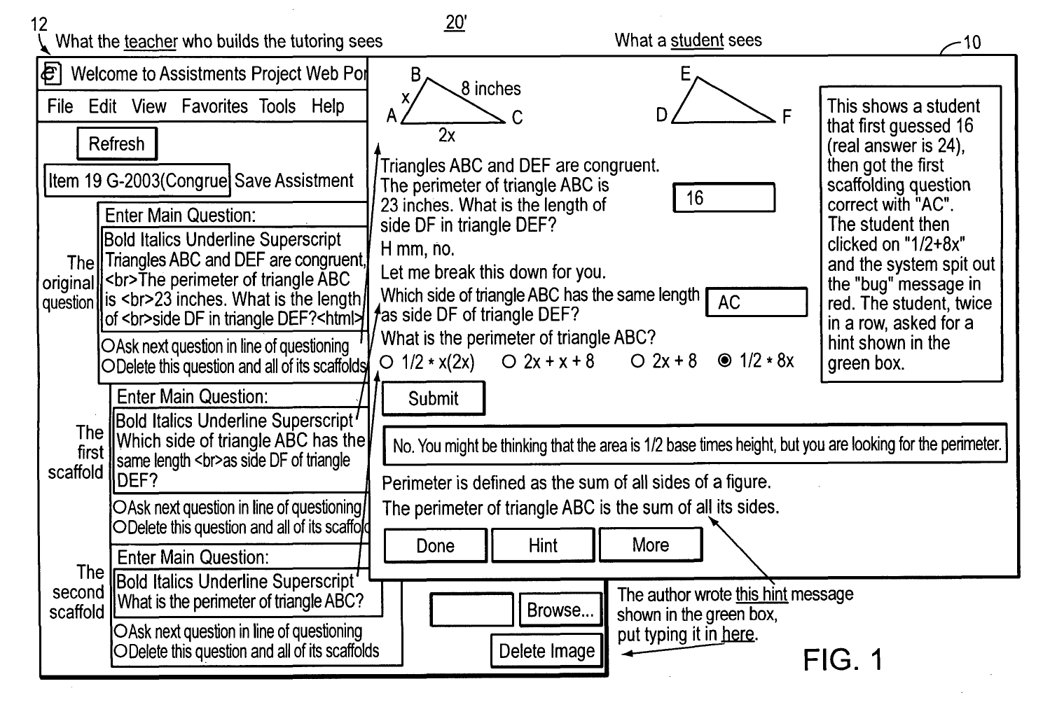

The ASSISTment system is a web-based assessment and tutor system 20′ that gives tutoring on questions or subject topics which students have shown signs of having difficulty learning. Once students log into the system 20′, they are presented with subject items, for example, mathematics items. The right side of FIG. 1 shows a screenshot 10 of a tutorial question for the 19th item on the 2003 Massachusetts Comprehensive Assessment System (MCAS) test. Without presenting all details, suffice it to say that if the student answers the question correctly, the system 20′ moves her on to a new question. In FIG. 1, the student incorrectly typed 16, to which the system responded with, “Hmm, no. Let me break this down for you.” This then engaged the tutor system 20′ to give the student some questions that will help isolate which of the skills she had erred on, and to give the student further tutoring so that she can figure out the correct actions to solving the subject item (problem or question). The tutor system 20′ began by asking a “scaffolding” question that both assesses the student's understanding of the subject matter and tutors her where she makes mistakes. The tutoring ends with a final question that asks the original question (subject item) again. Subsequently, the student continues to another MCAS item.

The left hand side of FIG. 1 shows the builder module 12 of the tutor system 20′, a web-based tool that teachers use to create content of tutorial questions and hints. Further details of embodiments of the builder module are found at least in International Patent Application Number PCT/US2006/027211 by assignee and herein incorporated by reference.

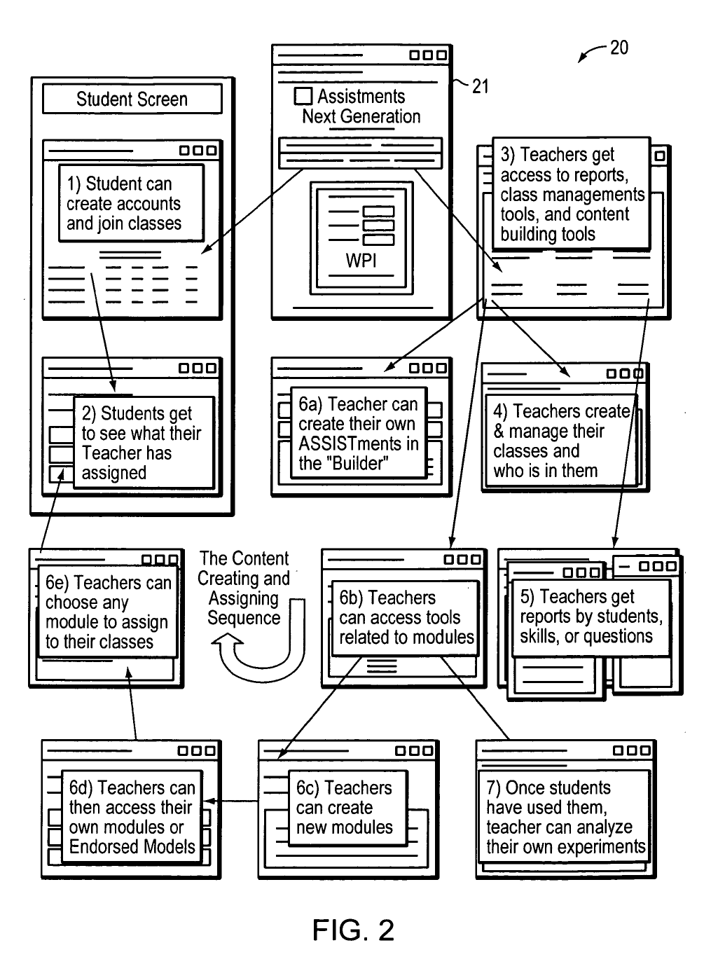

FIG. 2 provides an overview of one embodiment of the tutor system 20′ as extended by the present invention. By way of overview, the invention computer system 20, for tutoring students includes a tutoring system having a tutorial composer enabling a teacher to create tutorial modules by composing problems or by choosing problems from an existing approved (e.g. “Gold standard”) problem set to display to student-users. The teacher may invoke various media in composing problems. The tutorial composer also enables the teacher to form teaching strategies with at least serializing or scaffolding of problems. The scaffolding of problems includes transitioning or arcing from one problem to another. The invention system 20 further includes a self-teaching (student) module and a testing component.

The self-teaching module enables at least a first student to (a) compose one or more portions of a problem to provide to the teacher, and to (b) form self-teaching strategies. For each student-user, the tutoring system interactively displays to the student-user any combination of (i) the first-student composed problems, (ii) the teacher composed problems, or (iii) problems from the existing approved problem set according to a curriculum and the teaching strategies. The curriculum selects problems, and the teaching strategies enables any combination of student or teacher authored explanations, hints, messages and scaffolding of the problems to be interactively displayed in response to the student-user interaction/action. In one embodiment, the teaching strategies determine what messages, problems and media to display currently to the student-user and which are scheduled to be displayed to the student-user.

The testing component enables the teacher to test the quality of the first-student composed problems by conducting a randomized controlled experiment through the interactive display. In one embodiment, the testing component includes: a test group creator, a logger, and a comparer. The test group creator enables the teacher to create test groups. Different test groups are assigned to and interact with different problems. One test group interacts with the first-student composed problems. The logger logs results of each test group. The comparer compares the results of the various test groups.

The comparer may include a reporter that sends results of the comparison to an administrator. The testing component allows an administrator to add a student-composed problem to the approved (e.g. “Gold standard”) problem set.

In the FIG. 2 illustrated tutor system 20 of the present invention, there is a set of tools that allow teachers and students to perform all of the activities mentioned above. For the student user, FIG. 2 shows a main site or home page 21 leading to Student Login (1). From Student Login (1), a student proceeds to obtaining a list of assignments (2). Subsequently, on student-user selection of one of the listed assignments, the selected assignment is launched and displayed as in the right hand side 10 of FIG. 1.

FIG. 2 also illustrates the series of screens (tools) accessed by a teacher-user. From the main site page 21, a teacher is provided a screen (3) offering access points to reports, class management tools and content building tools. Upon teacher selection of class management tools, the system 20 displays screen views (4) prompting the teacher to create classes, i.e., name the students in each class, and to manage each class.

Upon teacher selection of reports from access screen (3), the system 20 displays screen views enabling the teacher to generate a variety of reports (5). For example, the teacher may generate reports by individual student, by certain skill, by question (subject topic) and the like. Common report generation techniques support this functionality of the tutor system 20.

Upon teacher selection of content building tools from access screen (3), the system 20 displays a series of screen views 6a-6e implementing the “Builder”. In screen view 6a, the builder module enables the teacher to create and enter content for tutorials. To assist, the system enables the teacher to access her prior authored content and content authored by others (screen view step 6b). The content authored by others includes student authored content in the current invention. Through screen views/steps 6c-6e, the teacher bundles content together to form tutorial modules and posts these modules (tutorials) for use. From the posted tutorial modules (of her own creation or endorsed ones), the teacher chooses which tutorial modules to assign to which classes/students (step 6e). Based on this assignment, the system 20 displays certain tutorials to certain students in step (2) and FIG. 1 above.

The present invention further provides working reports (step 7) on gain scores of students and on results of randomized experiments. The system 20 conducts randomized experiments by randomly assigning students to conditions and having students work through assigned tutorials following those conditions. The system 20 conducts a pretest and a posttest of the students and determines a gain score (difference between post test score and pretest score). Using the gain scores, the system 20 automatically analyzes the results of experiments and reports the analysis to teachers (step 7). This analysis assists in determining if learning is happening for the student-author which is at the heart of the present invention discussed later.

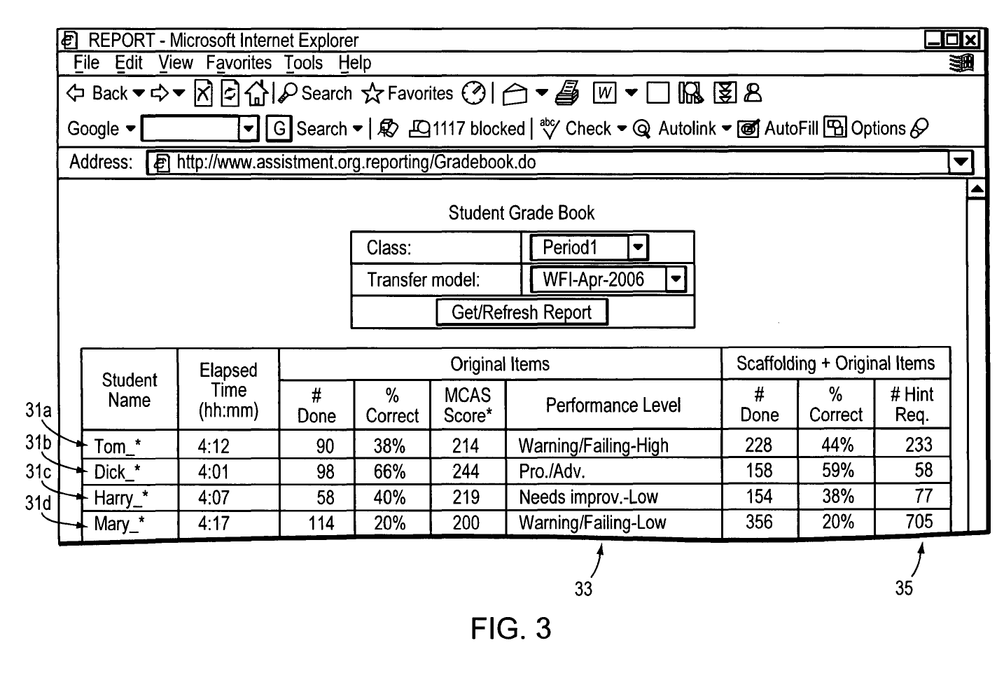

One embodiment of the tutor system 20′ (minus the present invention student-authoring feature) has tutoring associated with every one of the 300 released 8th grade MCAS items, using a tool developed with funding from the Office of Naval Research (who wanted to see the authoring of intelligent tutoring system could be more cost-affordable). Teachers get instantaneous feedback on their students' use of the system with multiple types of web-based reports. In FIG. 3, we instantly see Tom, Dick, Harry and Mary's data 31a, b, c, d. Tom has spent 4 hours and 12 minutes using the system this year, has done 90 MCAS problems, and gotten 38% correct. The system predicts his MCAS score to be 214 and this will give him a warning (i.e., failing) score 33. There are other details that describe how he is doing on the Scaffolding questions given during tutoring when he fails to get an MCAS item correct. The last column 35 (furthest to right hand side) is the number of hints he has requested. We see that Mary has asked for the most hints i.e., 705 in line 31d, column 35. A teacher can use this information to have a discussion with Mary about the appropriate ways to use the hints provided by the tutorial. These hint attempts, and other metrics, can be used to build an effort score (Walonoski, J. & Heffernan, N. T., Detection and Analysis of Off-Task Gaming Behavior in Intelligent Tutoring Systems. In Ikeda, Ashley & Chan (Eds.) Proceedings of the Eight International Conference on Intelligent Tutoring Systems, Springer-Verlag: Berlin. pp. 382-391, 2006) herein incorporated by reference.

The same reporting subsystem is employed in embodiments of the present invention system 20.

It is often said, “The best way to learn something is to have to teach it.” Applicants investigate this hypothesis and see if it is possible that students can learn mathematics by using sophisticated web-IT (i.e., a set of information technologies pertinent to a global computer network as opposed to more general IT such as understanding how hard drives function) to develop intelligent tutoring content for their peers.

It is also often said, but nevertheless correct, “the web changes everything.” Consider the case in point of www.Wikipedia.org, the web-based encyclopedia whose content is edited by (partially) anonymous and potentially random individuals. According to a recent study in the journal Nature, Wikipedia has a similar number of errors as the Encyclopedia Britannica and a much larger amount of up-to-date content. Wikipedia demonstrates what one calls “open-content” and while it would have seemed unrealistic before the Web to allow random individuals to build content, there are mechanisms that allow such a decentralized process to work (i.e., allow experts on a topic to be notified if someone changes an article on this topic).

Wikipedia is amazingly successful, even though it suffers from the inherent flaw that the system itself cannot determine the quality of a user's contribution. With the present invention, Applicants build off of existing web-based intelligent tutoring system called the ASSISTment system of Razzaq, L., Feng, M., Nuzzo-Jones, G., Heffernan, N. T., Koedinger, K. R., Junker, B., Ritter, S., Knight, A., Aniszczyk, C., Choksey, S., Livak, T., Mercado, E., Turner, T. E., Upalekar. R, Walonoski, J. A., Macasek. M. A. & Rasmussen, K. P. (2005). The Assistment Project: Blending Assessment and Assisting. In C. K. Looi, G. McCalla, B. Bredeweg, & J. Breuker (Eds.) Proceedings of the 12th Artificial Intelligence In Education, Amsterdam: ISO Press. 555-562 and described in International Patent Application PCT/US2006/027211 of assignee herein incorporated by reference.

Briefly, students use the tutoring system 20 every two weeks as part of their normal math classes. These students get tutoring while their teachers obtain accurate assessment data that can be used to refine their classroom instruction. The present invention extends the prior tutor system so that students can create content for tutorials of the tutoring ASSISTment system 20′.

The present invention improves on the success of Wikipedia because the invention system tells if a student's newly created content is actually helpful by conducting a randomized controlled experiment where students are randomly assigned to receive the newly created content or to a control group that uses the existing “Gold Standard” content. All students take a post-test on a third group of items focused on the same content. The invention system compares post-test scores to an ANOVA (analysis of variance) to see if there are reliable differences between the student content and the “Gold Standard” content.

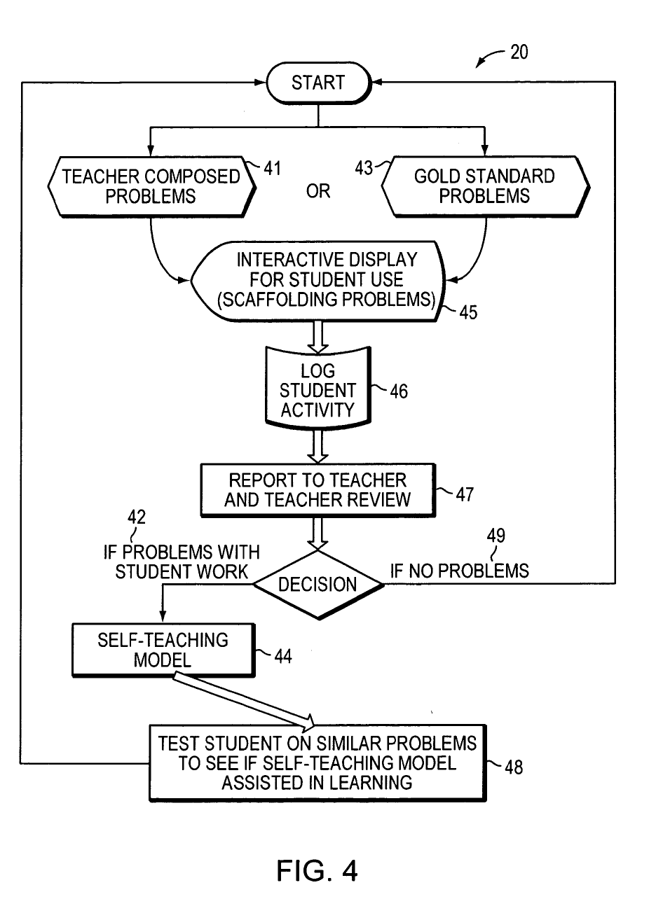

FIG. 4 illustrates the first step of the current invention system 20. First a teacher has the choice of using tutoring content from a current “Gold Standard” 43 or compose her own 41 tutorial problems. Over time the gold standard 43 may present new additions or substitutions of content including student authored content as will be made clear later. After this choice is made, the teacher assigns the problem (tutorial) to students through the interactive web-based display 45 described above in step 6e of FIG. 2. The invention system 20 logs 46 (e.g., into a data store) student activity with the assigned tutorial and reports the results to the teacher. Using the reports, the teacher reviews 47 the students' activities and determines if any student needs further assistance. If a student is reportedly meeting tasks/correctly answering tutorial questions without much difficulty 49 then the teacher moves on to the next subject matter for that student. On the other hand if a student is having difficulty 42, the teacher assigns to the student the task 44 of creating his own tutorial in the subject area. This introduces (launches) the self teaching module 44 of the present invention. Finally, the student is tested 48 on the material to see if the self-teaching strategy helped the student learn the subject area.

Alternatively the teacher may have a student, who at step 47 reportedly did well with the assigned tutorial, create contents for a tutorial in the subject area. This will also launch the invention model 44.

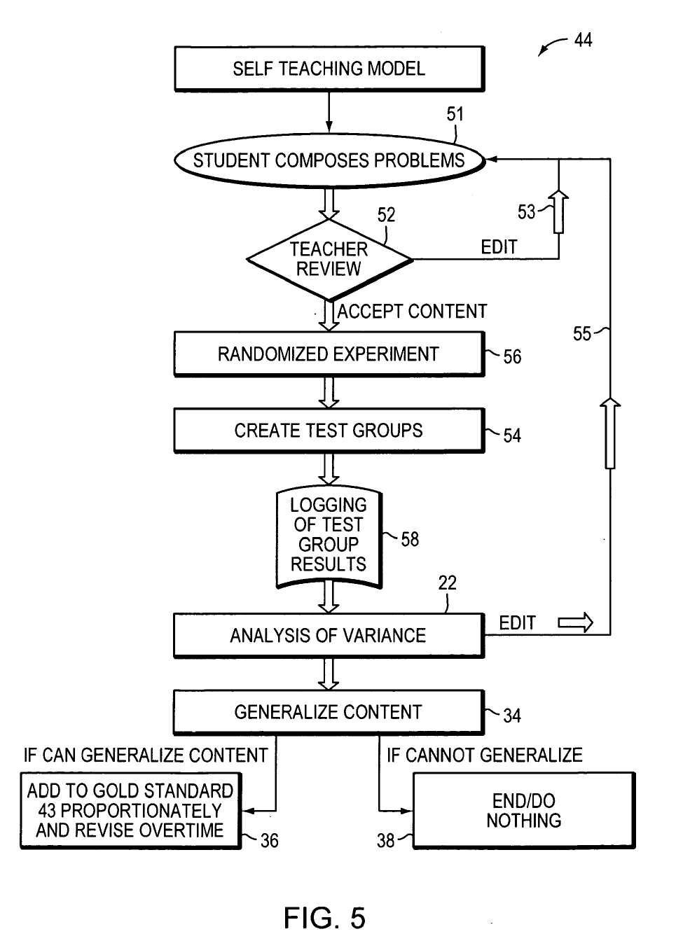

FIG. 5 illustrates the details of one embodiment of the self-teaching model 44. The student is assigned the task of researching a subject area and is assigned the task of creating a tutorial problem from that subject matter. The student drafts or otherwise composes one or more proposed tutorial problems 51. The teacher reviews 52 the student created content. If the teacher does not approve of the content, she has the student edit, modify or re-create a new tutorial problem. This may occur several times as indicated by loop 53.

Once the teacher accepts the student content, system 20 conducts a randomized controlled experiment 56. In this experiment 56, system 20 creates test groups 54, and then conducts tutorial sessions (employing the student-authored tutorial) with the test groups to test the quality of the student-authored content. At least one test group uses gold standard content in its tutorial session while another test group uses the student-authored tutorial. Pretutorial test scores of the test groups and post tutorial test scores of the test groups are compared (mathematical difference taken) and stored 58. The randomized controlled experiment 56 may be iterated with other test groups.

The stored difference scores represent the gain scores of the various test groups. A statistical analysis 22 of the gain scores provides an indication of whether students have a tendency to learn the subject more readily from the student authored content as compared to learning from the gold standard content. Based on this analysis 22, the invention system 20 may indicate that the student authored content is not promising (does not have potential) 55. If the student-authored content seems to have potential (i.e., tested students appear to be learning the subject topic more readily than those using the gold standard content) the system 20 determines if the student-authored content can be generalized 34 to other schools, classrooms, teachers, etc. If the content can be generalized, step 34 generalizes the student-authored content and adds 36 it to the current “Gold-standard” set of tutorial problems 43. If the content cannot be generalized, the content remains school or class specific 38.

In a preferred embodiment, step 36 adds the student-authored content to gold standard set of tutorial problems 43 in proportion to the evident (at 22) that supports it. Further over time, the gain scores of students having been tutored with the student-authored content added to the gold standard set 43 may further support the student-authored content. In some cases, the ongoing evidence may support the student-authored content replacing the corresponding gold standard content.

To give a concrete example, suppose the tutoring system 20 website tells teacher Ms. Jones that Johnny does not know how to do the Pythagorean Theorem. Ms. Jones gives to Johnny the homework assignment of researching the Pythagorean Theorem, and ask Johnny to build new content (questions with tutoring content 20, i.e., hints and suggestions attached). If Ms. Jones thinks Johnny did a good job with the assignment, she employs the invention system 20 to test to see if his content is good. That is, Ms. Jones conducts a randomized controlled experiment through tutor system 20 where some students (Group I) get Johnny's content, and a second set of students (Group II) get some questions (tutorials) from the already existing “Gold Standard” tutorial content. Subsequently, all students are post-tested on a set of held-out “Gold Standard” questions. If Johnny's tutoring content is more helpful (aids in the learning process), the students of Group I will have a greater differential between pre- and post-test scores, but if Johnny's tutoring content is not helpful (e.g., maybe it just tells students the answer), then students that were randomly assigned to Johnny's content (Group I) will show statistically significantly smaller gains than students (Group II) assigned to the “Gold Standard” content.

If the students assigned to Johnny's content (i.e. Group I) did better on the post-test items then that serves as evidence that Johnny's content was effective at prompting learning. If Johnny's content is really good, it might even outperform the material used in the “Gold Standard” condition, in which case the present invention system 20 brings this to the attention of the teacher. That teacher finds some other teachers to run the same experiment comparing the “Gold Standard” content to Johnny's content. If Johnny's content again proves superior, the present invention system 20 generalizes the content for use by other schools/districts/states and causes the generalized version of Johnny's content to become part of the new or updated “Gold Standard” content.

Applicants hope that 1% of student-created content will be much better than current historical content, and if one can get thousands of students creating content, one will get a new set of “Gold Standard” content quickly. Known or common techniques are used to continuously update the “Gold Standard” content with the assistance of the computer, but the main idea of the present invention is to build an open-content system like Wikipedia for educational technology. In theory, determining the quality of educational software could be easier to do with a computer running randomized controlled experiments as described above.

In an example embodiment, students are initially asked to design their math problems and the accompanying tutoring (tutorial) on paper and then input their designs on the computer for homework. Because teachers have limited time for reviewing all of the new content on paper and later on the computer network, applicants suggest that they make use of peer reviews at both stages. Two weeks later, the student-authored content can be used in class and students rank the content. Perhaps 80% of students' time on these activities will be done as homework. In this way, all of the students can be involved in these activities and applicants hypothesize that students will still benefit from creating content although applicants recognize that only a small portion of the content will be quality work that can be incorporated into the tutor system.

Because the invention system 20 wants to know if Johnny benefits from creating his on-line tutorial content about the Pythagorean Theorem, the invention system 20 also tests Johnny's knowledge after he has created this content. The test includes randomly selected problems that Johnny has not seen before, and tracks his performance (i.e., determines if his performance is statistically significantly better than before he created his content). See step 48 in FIG. 4. Applicants hope to see that not only does Johnny learn about the Pythagorean Theorem but that his peers learn about the Pythagorean Theorem. Furthermore, while engaging in these activities, students learn how to use some web-IT, and are also inspired to see its usefulness. In one sense, the students are participating in a game where if they build good tutorials (tutoring contents), then their peers will learn more. Teachers could also award points to those students that create the best content.

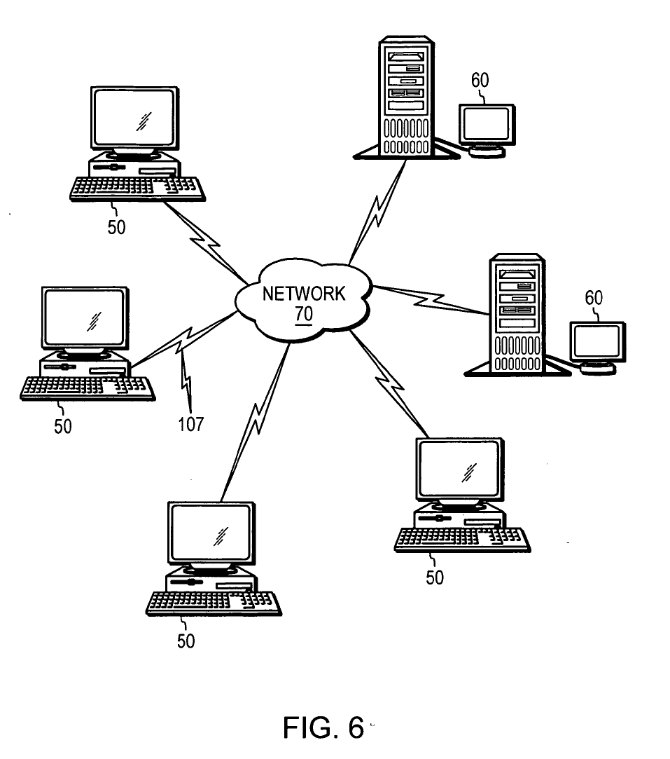

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

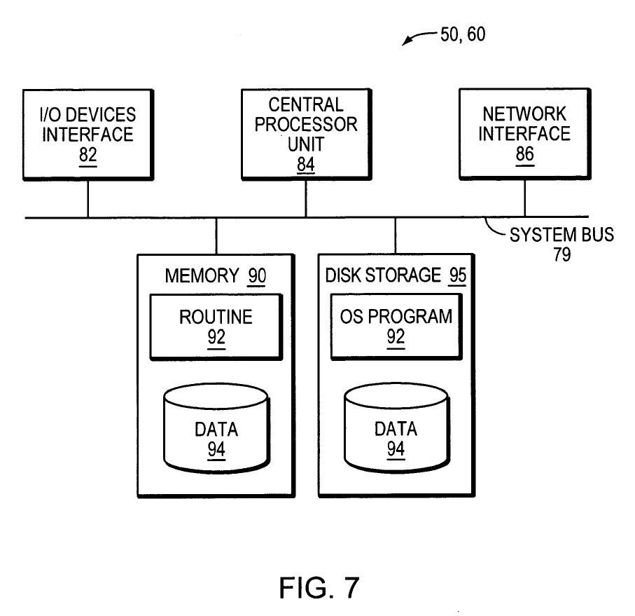

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., tutor system 20 with self-teaching model 44, Gold Standard tutorials, and other supporting data store logs 46, 58, etc, detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 6 and 7 are for purposes of illustration and not limitation of the present invention. Likewise, the flow diagrams of FIGS. 4 and 5 are for purposes of illustrating and not limiting one embodiment of the present invention. Other data arrangements and processor control configurations are suitable.

Advantages of the present invention include aiding teachers learn basic web-IT activities as well as learn how best to teach their students to use a sophisticated piece of web-based information technology. The invention tutoring system also provides a formative tool for teachers to learn what students are having difficulty with. Students benefit by learning to use web technologies to create a product that could potentially benefit thousands of students while learning school subjects/topics at the same time. Applicants hypothesize that students can learn by teaching their peers or others.

Another advantage posed by the present invention is the start of the next Wikipedia for educational technology usable by hundreds of thousands of teachers and millions of students. What's more, not only will students be able to create tutorial content themselves, the content can be tested for its quality.

A further advantage of this invention lies in the fact that it expands on the avenues a student can learn. The invention's premise is that “the best way to learn something is to teach it.” Students of similar age may be able to relate material to each other (peers) easier than a teacher may be able to relate the same material to a student.

What is claimed is:

1. In a global computer network, a method for tutoring students comprising the computer implemented steps of:
enabling a teacher to compose problems or to chose problems from an existing approved problem set to display to student-users and to form teaching strategies with at least scaffolding of problems; and
enabling a first student (a) to compose at least a portion of a problem to provide to the teacher and (b) to form self-teaching strategies; and
for each student-user, interactively displaying to the student-user any combination of (i) the first student composed problems, (ii) the teacher composed problems, or (iii) problems from the existing approved problem set according to a curriculum and the teaching strategies, the curriculum selecting problems and the teaching strategies enabling any combination of teacher or student authored explanations, hints, messages and scaffolding of the problems to be interactively displayed in response to the student-user interaction/action; and
enabling the teacher to test the quality of the first student composed problems by conducting a randomized controlled experiment through the interactive display.

2. A method as claimed in claim 1 wherein scaffolding employs arcing or transitioning from one problem to another problem.

3. A method as claimed in claim 1 wherein the step of enabling the teacher to compose problems includes enabling composed problems to include various media.

4. A method as claimed in claim 3 wherein the step of interactively displaying includes determining what messages, problems and media to display currently to the student-user and which are scheduled to be displayed to the student-user.

5. A method as claimed in claim 1 wherein the step of enabling a first student to compose problems includes enabling composed problems to include various media.

6. A method as claimed in claim 1 wherein the step of displaying is during runtime; and
the method further comprising the automated steps of:
logging the student-user actions and runtime level events, and storing indications of the logged student-user actions, curriculum and composed problems.

7. A method as claimed in claim 6 further comprising the step of reporting students-user's progress to teachers using the stored indications, said reporting including real-time reporting to teachers.

8. A method as claimed in claim 1 wherein the step of conducting a randomized controlled experiment includes:
(a) creating a first test group and a second test group, the first test group interacting with problems from the existing approved problem set, the second test group interacting with the first student composed problems;
(b) for each test group, logging test group results, and comparing results from each test group; and
(c) optionally iterating the randomized controlled experiment to statistically learn gains.

9. A method as claimed in claim 8 further comprising generalizing the first student composed problems to other schools.

10. A method as claimed in claim 9 wherein the step of generalizing the first student composed problem includes adding the first student composed problems to the approved problem set.

11. A method as claimed in claim 8 wherein the step of creating the first and second test groups includes creating additional test groups.

12. A method as claimed in claim 1 wherein the first student is one of the student-users or is a peer to the student-users.

13. In a global computer network, a computer system for tutoring students comprising:
a tutoring system having a tutorial composer enabling a teacher to create tutorial modules by composing problems or choosing problems from an existing approved problem set to display to student-users and to form teaching strategies with at least scaffolding of problems; and
a self-teaching module enabling at least a first student to (a) compose at least a portion of a problem to provide to the teacher and to (b) form self-teaching strategies; and
wherein for each student-user, the tutoring system interactively displaying to the student-user any combination of (i) the first student composed problems, (ii) the teacher composed problems, or (iii) problems from the existing approved problem set according to a curriculum and the teaching strategies, the curriculum selecting problems and the teaching strategies enabling any combination of teacher or student authored content to be interactively displayed in response to the student-user interaction/action; and
a testing component enabling teachers to test the quality of the first student composed problems by conducting a randomized controlled experiment through the interactive display.

14. A system as claimed in claim 13 wherein the teaching strategies employ any combination of explanations, hints, messages and scaffolding of problems.

15. A system as claimed in claim 14 wherein scaffolding employs arcing or transitioning from one problem to another problem.

16. A system as claimed in claim 13 further comprising a reporting component enabling real time reporting of student-user's work/progress to teachers, and further including:
a logger for logging student user actions and framework level events; and
a data store coupled to the logger for storing indications of logged student user actions, curriculum, problem information and media.

17. A system as claimed in claim 13 wherein the testing component includes:
a test group creator enabling the teacher to create test groups, different test groups interacting with different problems, one test group interacting with the first student composed problems;
a logger for logging results of each test group; and
a comparer for comparing the test group results, the comparer including a reporter that sends results of the comparison to an administrator.

18. A system as claimed in claim 13 wherein the testing component further allows a student composed problem to be added to the approved problem set.

19. A system as claimed in claim 13 wherein the first student is one of the student-users or is a peer to the student-users.

20. A computer program product providing a tutoring system comprising:
a computer useable medium having a computer readable program;
wherein the computer readable program when executed on a computer causes the computer to:
enable a teacher to compose problems or to chose problems from an existing approved problem set to display to student-users and to form teaching strategies;
enable a first student (a) to compose at least a portion of a problem to provide to the teacher and (b) to form self-teaching strategies.
interactively display, to each student-user, any combination of (i) the first student composed problems, (ii) the teacher composed problems, or (iii) problems from the existing approved problem set according to a curriculum and the teaching strategies, the curriculum selecting problems and the teaching strategies enabling any combination of teacher or student authored explanations, hints, messages and scaffolding of the problems to be interactively displayed in response to the student-user interaction/action; and
enable the teacher to test the quality of the first student composed problems by conducting a randomized controlled experiment through the interactive display wherein the first student is one of the student-users.

21. A computer program product as claimed in claim 20 wherein the computer readable program further causes the computer to add a student composed problem to the approved problem set.

22. In a global computer network, a computer system for tutoring students, comprising:
tutorial composing means for enabling a teacher to compose problems or to chose problems from an existing approved problem set to display to student-users and to form teaching strategies;
self-teaching means for enabling a first student to (a) compose at least a portion of a problem to provide to the teacher and to (b) form self-teaching strategies;
means to interactively display to each student-user, any combination of (i) the first student composed problems, (ii) the teacher composed problems, or (iii) problems from the existing approved problems set according to a curriculum and the teaching strategies, the curriculum selecting problems and the teaching strategies enabling any combination of teacher or student authored explanations, hints, messages and scaffolding of the problems to be interactively displayed in response to the student-user interaction/action; and
test means for enabling the teacher to test the quality of the first student composed problems by conducting a randomized controlled experiment through the interactive display.

23. A computer system as claimed in claim 22 further comprising means for adding the first student composed problems to the approved problem set.

24. A computer system means as claimed in claim 22 wherein the first student is a student-user or a peer to the student-users.
